(19) United States
(12) Patent Application Publication
(10) Pub. No.: US 2026/0307333 A1
(43) Pub. Date: Oct. 8, 2026

(54) PERFORMANCE OF MATERIALS GENERATED VIA CONVENTIONAL ADDITIVE MANUFACTURING THROUGH SOLVENT INDUCED EXPANSION ANNEALING

(71) Applicants: Zhe Qiang, Hattiesburg, MS (US); Zoe Gunter, Hattiesburg, MS (US)

(72) Inventors: Zhe Qiang, Hattiesburg, MS (US); Zoe Gunter, Hattiesburg, MS (US)

(73) Assignee: The University of Southern Mississippi, Hattiesburg, MS (US)

(21) Appl. No.: 19/634,392

(22) Filed: Mar. 31, 2026

Related U.S. Application Data
(60) Provisional application No. 63/783,025, filed on Apr. 3, 2025.

(51) Int. Cl. B29C 64/30; B33Y 40/20; B33Y 70/00; B33Y 80/00

(52) U.S. Cl. CPC B29C 64/30; B33Y 40/20; B33Y 70/00; B33Y 80/00

(57) ABSTRACT

An additive manufactured product comprising a plurality of printed layers of a partially or completely amorphous thermoplastic composition wherein adjacent layers of the plurality of layers are bonded by interfacial crystallites extending between the adjacent layers. The additive manufactured product can be made by a method including steps of additive manufacturing a composition comprising a partially or completely amorphous thermoplastic composition to form an additive manufactured article, immersing the additive manufactured article in one or more solvents in which the additive manufactured article is essentially insoluble at a temperature of at least 20° C. and below a boiling temperature of the one or more solvents to swell the additive manufactured article; and drying the additive manufactured article after the immersing step to form the additive manufactured product.

### BACKGROUND OF THE INVENTION

Additive manufacturing (AM) technologies have been developed to address the limitations of traditional manufacturing, as they are able to generate rapid prototyping samples from 3D models. Specifically, material extrusion (MEX)-based AM can be used to generate controlled multi-material specimens as well as large-scale structures, both of which are not attainable using other AM methods. Furthermore, as this method of AM is widely accessible, its implementation in academic and industrial applications offers great promise as a transformative approach.

MEX-AM specimens possess inherently poor interlayer adhesion due to rapid cooling of material after deposition during the printing process which restricts interlaminar chain diffusion and subsequent formation of entanglements. Additionally, for semi-crystalline polymers, crystallization can occur rapidly after material deposition, further restricting chain mobility and interlayer interaction. Due to these limitations, MEX-AM specimens exhibit anisotropy, demonstrated through print orientation-dependent mechanical properties, halting further implementation of this AM method. For example, while bulk polypropylene exhibits high toughness and extensibility, its 3D printed counterpart shows significantly diminished properties, especially when printed in the transverse direction. More specifically, bulk polypropylene can possess a range of elongation at break values, reaching up to 800% while 3D printed polypropylene specimens possess much lower values of approximately 46% when printed in the transverse (z) direction. This is predominately due to poor interlayer adhesion which greatly reduces mechanical properties and results in anisotropy.

While contemporary methods to improve the interlayer adhesion of MEX-AM have been explored, they often require the use of additives or extended periods of time to achieve an interfacial strength improvement, limiting their viability. Previous approaches to addressing this significant bottleneck in MEX-AM often require complex or costly processes.

For example, interlayer adhesion has been improved through the addition of thermally conductive additives either coated onto or blended into polymer filaments which enable interlayer welding upon irradiation. While this process has allowed for significant improvements in interlayer strength (as much as 275% relative to transverse 3D printed control), it requires the inclusion of additional components or additives which alter the appearance of the 3D printed specimen and are difficult to disperse.

Interlayer adhesion improvements have also been observed using low molecular weight surface segregating additives. These additives allow for improved interlayer diffusion and the formation of entanglements, thus increasing the maximum tensile stress of samples printed out-of-plane (z-direction) by as much as 40%. However, designing surface segregating additives for matrix compatibility is complex and property improvements are variable due to interlayer diffusion limitations.

While solvent immersion has been commonly employed in MEX-AM to enhance surface properties of final products like roughness through techniques such as chemical bath finishing, no existing method leverages controlled solvent-induced swelling of polymer products to improve their mechanical properties and reduce anisotropy of 3D-printed parts by improving interfacial strength between printed layers via intra or intermolecular chain entanglement formation and/or crystallization.

U.S. Pat. No. 12,179,418 relates to methods of forming porous and microporous parts prepared by additive manufacturing. The methods include steps of printing a composition including a soluble and insoluble component using an additive manufacturing process, exposing the additive manufactured product to a solvent, then dissolving the soluble component to form a porous material.

Additionally, US2023/0091181 A1 relates to methods of smoothing the surface of an additively manufactured polymer part. The method includes using a vaporized solvent to create a condensate on the surface of the additively manufactured polymer to dissolve at least a portion of the upper layer of the additively manufactured polymer to make a smooth surface.

### SUMMARY

The present invention relates to methods of forming MEX-AM materials with improved interfacial adhesion and isotropy using a simple, cost-effective solvent-induced expansion mechanism hereinafter referred to as expansion annealing. The additive manufactured products produced by the methods described herein possess improved tensile properties, including toughness and elongation at break, which are approximately 596% and 605% greater than comparable MEX-printed samples without use of solvent expansion annealing. Tear strength of expansion annealed specimens was also improved by 75% relative to 3D-printed control specimens. Additionally, macroscopic retention of structure was observed after solvent immersion, with less than a 2% change in dimensions after a drying period of 72 hours under ambient conditions. Regarding macro- and nanoscopic features, a reduction in voids is observed and crystalline structures are formed upon solvent removal, with the degree of crystallinity increasing by 3% witnessed after a 72-hour drying period.

The present invention may be described by the following sentences:
1. In a first aspect, the present invention relates to an additive manufactured product, comprising:
a plurality of printed layers of a thermoplastic composition, wherein each layer of the plurality of layers comprises amorphous regions and crystalline domains; and
wherein adjacent layers of the plurality of layers are bonded by interfacial crystallites extending between the adjacent layers.
2. The additive manufactured product of sentence 1, wherein the thermoplastic composition comprises one or more polymers selected from the group consisting of polyolefins, polylactic acid, acrylonitrile butadiene styrene, polyethylene terephthalate glycol, polycarbonate, thermoplastic polyurethane and polyamide.
3. The additive manufactured product of sentence 1, wherein the thermoplastic composition comprises a polymer selected from the group consisting of polyolefins, polylactic acid, polyethylene terephthalate glycol and polyamide.
4. The additive manufactured product of sentence 3, wherein the polymer is a polyolefin selected from the group consisting of polyethylene and polypropylene.
5. The additive manufactured product of any one of sentences 1-4, wherein the interfacial crystallites have an average lamellar thickness greater than an average lamellar thickness of the crystalline domains within the layers
6. In a second aspect, the present invention relates to a method of making an additive manufactured product, including steps of:
   additive manufacturing a composition comprising a thermoplastic composition to form an additive manufactured article;
   immersing the additive manufactured article in one or more solvents in which the material is essentially insoluble at a temperature of at least 20° C. and below a boiling temperature of the one or more solvents to swell the additive manufactured article; and
drying the additive manufactured article after the immersing step to remove residual volatile solvent content from the additive manufactured article.
7. The method of sentence 6, wherein the step of additive manufacturing may be selected from the group consisting of material extrusion, stereolithography, powder bed fusion, binder jetting, and sheet lamination.
8. The method of any one of sentences 6-7, wherein the thermoplastic composition may include one or more polymers selected from the group consisting of polyolefins, polylactic acid, acrylonitrile butadiene styrene, polyethylene terephthalate glycol, polycarbonate, thermoplastic polyurethane, and polyamide, optionally, the polyolefin is selected from the group consisting of polyethylene and polypropylene.
9. The method of any one of sentences 6-8, wherein the solvent system utilized may have a temperature of from about 20° C. to about 85° C., or from about 20° C. to about 60° C., or from about 30° C. to about 50° C. selected based on the desired degree of expansion of the polymeric material.
10. The method of any one of sentences 6-9, wherein the step of immersing the additive manufactured article in the solvent isotropically swells the additive manufactured article by 1% to 61%, based on a volume of the additive manufactured article prior to immersion and the immersion temperature.
11. The method of any one of sentences 6-10, wherein the step of immersing the additive manufactured article may be carried out for a duration of from about 50 minutes to about 24 hours, or from about 50 minutes to about 2.5 hours depending on the time that needed for samples to reach the required expansion/swelling degree.
12. The method of any one of sentences 6-11, wherein at least one of the one or more solvents may be an organic solvent.
13. The method of any one of sentences 6-12, wherein the one or more solvents may be selected from the group consisting of xylenes, aromatic hydrocarbons, ketones, esters, aliphatic alcohols, aliphatic hydrocarbons, aliphatic diols, aprotic polar solvents, halogenated solvents, and combinations thereof.
14. The method of any one of sentences 6-13, wherein the step of drying may be carried out for a duration of 24 hours to 168 hours, or from about 30 hours to 120 hours, or from about 48 hours to 72 hours either under ambient drying conditions or by using elevated temperatures and vacuum drying.
15. The method of any one of sentences 6-14, wherein the step of drying may be carried out until the solvent is essentially removed from the additive manufactured article to form the final additive manufactured product.
16. In a second aspect, the present invention relates to an additive manufactured product formed by the method of any one of sentences 6-15.
17. The additive manufactured product of sentence 16, having an improvement in toughness of at least 73% and up to 596% relative to the additive manufactured article.
18. The additive manufactured product of any one of sentences 16-17, having an improvement in tear strength of at least 24% and up to 73% relative to the additive manufactured article.
19. The additive manufactured product of any one of sentences 16-18, having an improvement in elongation of break of at least 77% and up to 605% relative to the additive manufactured article.
20. The additive manufactured product of any one of sentences 16-19, wherein one or more layers of the additive manufactured product comprises an increased degree of entanglements or interlayer crystallites resulting from the immersing and drying steps, as determined by an increase in tear strength and elongation at break, relative to the additive manufactured article that has not been immersed in the one or more solvents.
21. In a third aspect, the present invention relates to a method of improving isotropy of an additive manufactured product comprising steps of:
   immersing an additive manufactured article comprising a thermoplastic composition in a solvent at a temperature of at least 20° C. and below a boiling temperature of the solvent to swell the additive manufactured article; and
   drying the additive manufactured article after the immersing step to form the final additive manufactured product; and
wherein the thermoplastic composition is essentially insoluble in the solvent.
22. In a fourth aspect, the present invention relates to a method of improving interlayer crystallization or interlayer entanglements and interlayer adhesion of an additive manufactured product comprising steps of:
   immersing an additive manufactured article in a solvent at a temperature of at least 20° C. and below a boiling temperature of the solvent; and
   drying the additive manufactured article after the immersing step to form the final additive manufactured product; and
wherein the thermoplastic composition is essentially insoluble in the solvent.

### BRIEF DESCRIPTION OF THE DRAWINGS

FIG. 1A shows a schematic in image a), illustrating the expansion annealing process according to the present invention. As shown, starting from an untreated sample before immersion, as printed (left), the sample directly after immersion, swollen (middle), and the sample after drying, dried (right). Image b) of FIG. 1A shows photos of the samples undergoing the expansion annealing process, untreated, before immersion (left), directly after immersion (middle), and after 72 hours of drying with macroscopic structural retention (right).

FIG. 1B illustrates the expansion annealing process.

FIG. 1C shows a chart of average swelling equilibrium thickness change for temperatures ranging from 25° C. to 80° C.

FIG. 2 shows a stress vs. strain plot of MEX-AM polypropylene (PP) tensile bars with an untreated sample printed along the out-of-plane direction (black dashed line) and an expansion annealed sample printed in the out-of-plane direction, annealed at 50° C. for 2.5 hours, and vacuum dried at 40° C. for 48 hours (blue).

FIG. 3A shows in-situ, Lorentz corrected small angle X-ray scattering (SAXS) profiles of PP immersed at temperatures ranging from 25° C. to 70° C.

FIG. 3B shows a chart of long period (L) as a function of immersion temperature.

FIG. 3C shows in-situ wide angle X-ray scattering of PP annealed at temperatures ranging from 25° C. to 70° C.

FIG. 4A shows an illustration demonstrating printing orientation of out-of-plane printed tensile bars and stress vs. strain curves for unannealed and annealed samples, immersed for 150 minutes at temperatures ranging from 25° C. to 60° C.

FIG. 4B shows an image displaying unannealed and annealed tensile bars post-fracture.

FIG. 4C shows a chart of tensile properties of unannealed and annealed PP, including tensile strength, elongation at break, and toughness.

FIG. 4D shows a chart of fracture strength of unannealed and annealed specimens.

FIG. 5A shows a chart of the degree of crystallinity and crystallization temperature of PP samples before and after annealing at various temperatures.

FIG. 5B shows a chart of Static Lorentz corrected SAXS profiles of unannealed and completely dried, annealed PP samples.

FIG. 5C shows a chart of lamellar thickness distributions of unannealed and annealed single filament traces, based on cooling thermograms.

FIG. 6A shows a chart of elongation at break as a function of printing orientation compared to bulk, compression molded samples.

FIG. 6B shows a chart of tensile strength as a function of printing orientation compared to bulk, compression molded samples.

FIG. 6C shows a chart toughness as a function of printing orientation compared to bulk, compression molded samples.

FIG. 6D shows an image exhibiting the different printing orientations tested in the working examples of the present application.

FIG. 6E shows images of complex structures that were printed before expansion annealing (left), immediately after immersion (middle), and after complete drying (right).

FIG. 7 shows a chart of thickness change as a function of time for polypropylene disks annealed in xylenes at temperatures ranging from 25° C. to 80° C.

FIG. 8A shows a chart of thickness changes as a function of time for a compression molded and 3D printed rectangular prism with a thickness of approximately 0.6 mm. These samples were immersed in xylenes at 50° C. for 150 min.

FIG. 8B shows a chart of thickness change as a function of time for step-like specimens with thicknesses ranging from 2 to 15 mm. These samples were immersed in xylenes at 50° C. for 150 min.

FIG. 9 shows polarized optical microscopy (POM) micrographs of unannealed PP in image A), in-situ annealed PP, annealed at 50° C. in xylenes in image B), and in image C) annealed PP after drying.

FIG. 10 shows a bar graph of tensile modulus values for unannealed and annealed samples. Each sample was immersed for 150 min in xylenes and dried for 48 h at 40° C.

FIG. 11 shows a chart of lamellar thickness distributions based on first-heat DSC thermograms of dual-layered filament traces annealed for 150 min at temperatures ranging from 25° C. to 60° C., with a shoulder region highlighting the lamellar thickness distributions in the temperature range of 70° C. to 130° C.

### DETAILED DESCRIPTION

The present invention relates to an additive manufactured product and methods of forming the additive manufactured product. The method of forming the additive manufactured product, including steps of:
a) additive manufacturing a composition comprising a thermoplastic composition to form an additive manufactured article; and
b) immersing the additive manufactured article in a solvent heated to a temperature below a boiling temperature of the solvent but at or above room temperature, approximately 20° C.-25° C.; and drying the additive manufactured article after the immersing step to form the additive manufactured product.

Preferably, the thermoplastic composition interacts with but is essentially insoluble in the solvent under immersion conditions utilized. The thermoplastic composition can be an amorphous polymer or a semi-crystalline polymer. The expansion annealing process selectively expands the amorphous portion of the thermoplastic composition to achieve the desired results.

In the process, a combination of good solvent and non-solvent can be employed in different ratios to control the swelling degree, allowing the thermoplastic polymers to expand and form interlayer crystallites or entanglements upon drying, Use of different ratios of good solvent and non-solvent is shown in the working examples of the application. The desired results of the expansion annealing process can be carefully controlled by tuning this ratio of good solvent to non-solvent.

This method was developed for material extrusion additive manufacturing (MEX-AM) but may be applied to a variety of additive manufacturing methods, such as, for example, the following suitable methods, stereolithography, powder bed fusion, binder jetting, and sheet lamination.

The compositions utilized for additive manufacturing include thermoplastic compositions that are essentially insoluble in the solvent under the immersion conditions used. Essentially insoluble means that less than 1% of the thermoplastic composition dissolves in the solvent. The advantage of this is that there is less than 1% mass loss or no mass loss as a result of the expansion annealing process. For example, the thermoplastic composition may comprise one or more polymers selected from polyolefins (e.g. polyethylene, polypropylene, polybutene, polymethylpentene), polylactic acid, acrylonitrile butadiene styrene, polyethylene terephthalate glycol, polycarbonate, thermoplastic polyurethane, or polyamide.

Once the composition is additively manufactured via MEX-AM, the manufactured article is immersed in the solvent. This step causes the manufactured article to achieve isotropic swelling upon reaching equilibrium by 10.5% to 31%, based on the dimensional changes of the manufactured article prior to immersion, depending on the temperature utilized during immersion. This step may also be referred to as a step of annealing the manufactured article since the solvent is heated to a temperature of from about 20° C. to about 85° C., or from about 20° C. to about 60° C., or from about 20° C. to about 50° C. Preferably, the solvent is heated to a temperature no greater than the temperature at which material distortion or dissolution occurs and below its boiling point to avoid potential vaporization of the solvent. Maintaining a relatively low heating temperature is advantageous as it prevents degradation of the thermoplastic material, improves the mechanical properties of the article, and reduces potential costs associated with operating at higher temperatures.

The manufactured article may be immersed in the heated solvent for a duration of, for example, from about 30 minutes to about 24 hours, or from about 45 minutes to about 10 hours, or from about 50 minutes to about 2.5 hours.

The duration of immersion is determined by swelling behavior and the desired degree of expansion which is based on a combination of the type of solvent, the temperature, and the thermoplastic material used. In some embodiments, expansion is carried out until the thermoplastic composition reaches equilibrium in the solvent/non-solvent mixture though this is not necessary to achieve beneficial results and, in some cases, different time periods will be employed for the expansion annealing process based primarily on the desired degree of swelling/expansion.

The present method may employ xylenes, but other organic solvents may be selected for other thermoplastics, including aromatic hydrocarbons, ketones, esters, aliphatic alcohols, aliphatic hydrocarbons, aliphatic diols, halogenated solvents, aprotic polar solvents, and combinations thereof.

Once the manufactured article has achieved the desired degree of expansion, the swelled manufactured article is dried under ambient conditions or under vacuum at elevated temperatures until the solvent is essentially removed from the manufactured article to form the desired additive manufactured product with improved mechanical properties. In some embodiments, the step of drying is carried out for a duration of 24 hours to 72 hours depending on material system and specimen thickness.

The present invention provides methods that significantly improve the mechanical properties of MEX-AM specimens through solvent-induced expansion of the amorphous portion of the material. By employing commonly used thermoplastic filaments with limited solubility, such as polypropylene (PP), and immersing the MEX-AM specimens in a suitable solvent at elevated temperatures, such as xylenes, for a defined period, the solvent can penetrate the sample, expanding the amorphous phase between crystalline domains, promoting enhanced chain mobility, and forming entanglements or crystallites in the process. As a result, the mechanical properties are significantly improved, and the anisotropy is greatly reduced.

The additive manufactured product produced by the method disclosed herein, maintains the macroscopic and microscopic structural integrity and geometry of the product while significantly improving the mechanical properties such as elongation at break by as much as 605%, and toughness by up to 596%. This results in nearly isotropic materials—a long-standing goal in the 3D printing industry. This process is advantageous since it is both cost-effective and efficient and it requires no additional components or expensive equipment.

The additive manufactured product may comprise a plurality of printed layers of a semi-crystalline thermoplastic composition, wherein each layer of the plurality of layers comprises amorphous regions and crystalline domains. Semi-crystalline materials have a degree of crystallinity of from 1% to 80%. The expansion annealing process can also be applied to amorphous polymers with beneficial results as demonstrated in Example 12 below. Adjacent layers of the plurality of layers are bonded by a network of interfacial structures comprising interfacial crystallites and tie-chains and molecular entanglements extending between the adjacent layers. The interfacial crystallites may have an average lamellar thickness greater than an average lamellar thickness of the crystalline domains within the layers.

### EXAMPLES

### Example 1

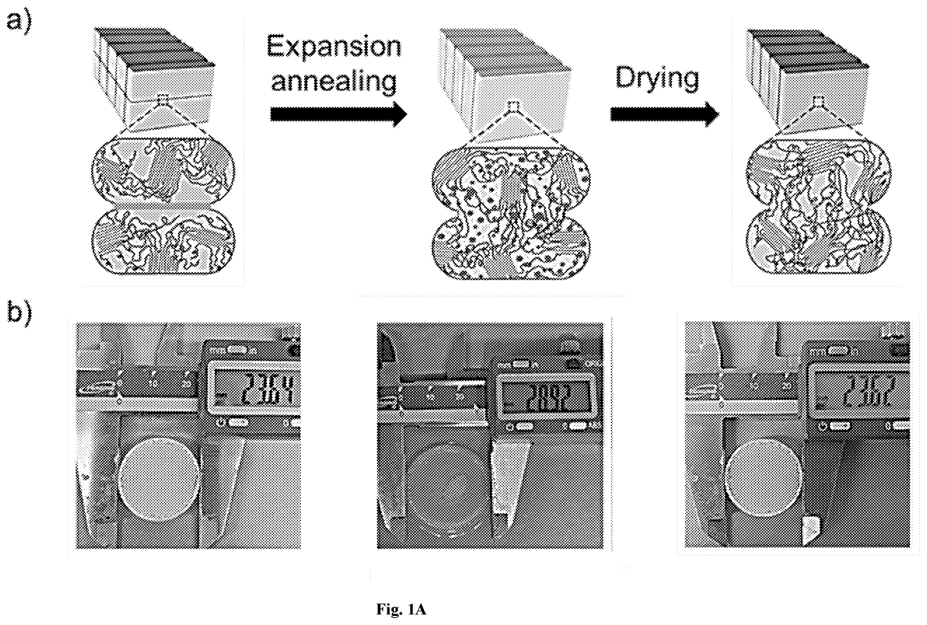

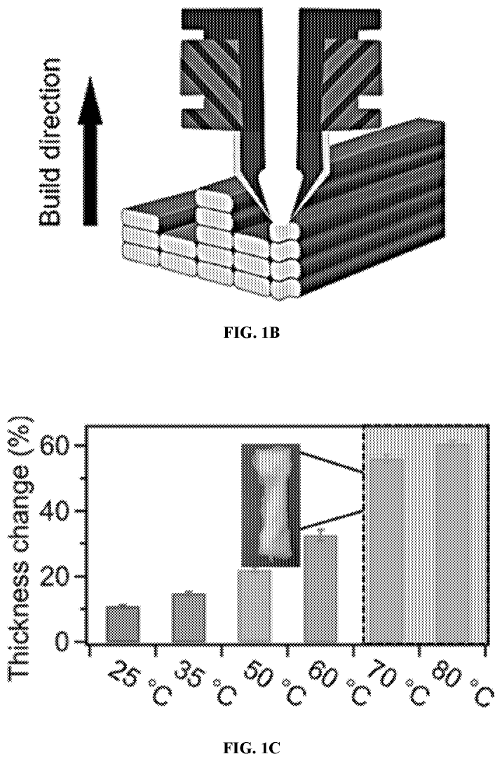

The expansion annealing method of the present invention may utilize polypropylene (PP) specimens printed using MEX-AM. The samples were immersed in xylenes at elevated temperatures in an expansion annealing step to induce isotropic swelling and promote interlayer crystallites while avoiding material dissolution. After conducting the expansion annealing step for a period determined by the particular swelling behavior and equilibrium of the PP material employed, the samples were removed from the solvent and allowed to dry for up to 72 hours before being characterized. A schematic of the expansion annealing process as well as images of polypropylene disc samples before expansion annealing, immediately after expansion annealing, and after drying for 72 hours are shown in FIG. 1A, images a)-c), respectively.

After drying, macrostructural retention was observed, since the samples returned to their original dimensions and mass with less than a 1% change in both. Furthermore, it was observed that expansion annealed samples possessed an enhanced degree of crystallinity after drying, with up to a 3% increase in the degree of crystallinity when expansion annealed at temperatures ranging from 25° C. to 60° C.

### Example 2

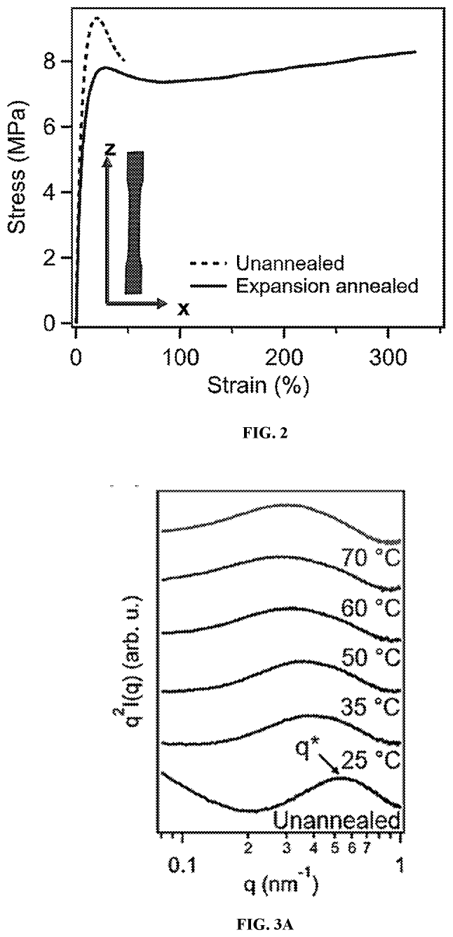

Based on the performance of the PP disc samples (as seen in FIG. 1A, image b), tensile and trouser tear specimens were printed (based on ASTM D638 and ASTM D624 standards, respectively) and treated to evaluate the effect of the expansion annealing process on the mechanical properties of MEX-AM specimens. Tensile results for annealed samples printed in the out-of-plane direction showed significant improvements in their toughness and elongation at break values relative to the out-of-plane, unannealed control sample (FIG. 2). Notably, PP specimens immersed in xylenes at 50° C. for 2.5 hours showed an increase in toughness of 596% and an improvement in elongation at break of 605% when evaluated employing uniaxial tensile experiments. These improvements are far beyond those achievable by other reported methods to date. Additionally, annealed trouser tear specimens displayed a 75% increase in tear strength relative to out-of-plane printed control samples.

For comparison, irradiation has been utilized to improve mechanical properties of AM specimens printed out-of-plane, notably displaying fracture strength improvements of 275% relative to a 3D printed control. However, this method requires the use of thermally conductive additives blended into or coated onto filaments, and mechanical property improvements are thus dependent on additive dispersion. In practice, it has been found that proper dispersion is difficult, resulting in variabilities in mechanical property improvements, making this approach somewhat complex.

Furthermore, the tensile mechanical properties of the annealed sample more closely resemble those of the in-plane printed control, thus demonstrating the ability of the expansion annealing process to improve both the mechanical properties and isotropy of MEX-AM materials. Based on these results, expansion annealing of MEX-AM materials provides a simple method for improving the structural integrity of samples by altering their morphological structure and enhancing interlayer adhesion. Compared to other contemporary methods, this process is both time and cost effective.

This process is particularly effective for semi-crystalline polymers like PP. The solvent selectively swells the amorphous phase, expanding chains and promoting interlayer crystallites, while the retention of crystalline domains enables the preservation of part geometry. Upon solvent removal, PP chains recrystallize, strengthening the interlayer adhesion and improving out-of-plane mechanical performance without sacrificing dimensional fidelity. As a result, model tensile specimens that were immersed in xylene at 50° C. for 150 min exhibited an elongation at break increase of 605% and a toughness increase of 596%. These improvements highlight the potential of expansion annealing for providing a robust, cost-effective method for improving the performance of MEX printed semi-crystalline polymers.

### Example 3

In one embodiment, PP was employed as the model system because it is a common semi-crystalline polymer used in MEX-AM, which exhibits a low glass transition temperature (T_{g}) that permits sample deformability and elongation. Prior annealing approaches have largely focused on glassy, rigid polymers, whereas PP-based systems remained relatively underexplored. An overview of the expansion annealing mechanism is shown in FIG. 1B. PP specimens were first printed by MEX in a continuous layer-by-layer process. Following printing, parts were immersed in xylene at controlled temperatures until reaching an equilibrium swelling state. The annealing temperature was varied to tune the degree of swelling and thus the extent of expansion of the amorphous domains, while the semi-crystalline framework remained intact, preserving the structural integrity of samples throughout the annealing process. After removal from the solvent, the samples were dried and recovered to their original state. Upon drying, solvent evaporation triggered chain recrystallization and intermolecular entanglements across adjacent layers (such as tie-chain formation), leading to enhanced interlayer adhesion in MEX-printed PP parts.

The macroscopic swelling behavior of the printed PP parts was investigated under different annealing temperatures in xylene by monitoring the dimensional changes of printed disk-shaped specimens (a model sample geometry). When annealed at temperatures ranging from 25° C. to 60° C., samples achieved an equilibrium swelling state within ~100 min (FIG. 7). As shown in FIG. 1B, image b), the extent of sample expansion at equilibrium increased with temperature, reaching 10.5% at 25° C. and 31% at 60° C. However, when annealing temperatures exceeded 60° C., significant sample distortion occurred.

Based on these observations, subsequent experiments were limited to immersion annealing temperatures within the range of 25° C. to 60° C. to ensure controlled swelling and structural integrity of the PP specimens. Additionally, dimensional measurements of the disk specimens at each temperature confirmed isotropic swelling, with less than 2% variation across both sample dimensions. After complete drying, the specimens recovered their original dimensions and mass, being nearly identical to the neat state (FIG. 1A, image b). This result confirms that expansion annealing can be used to engineer the properties of printed parts (post additive manufacturing) while fully retaining their macroscopic structure.

### Example 4

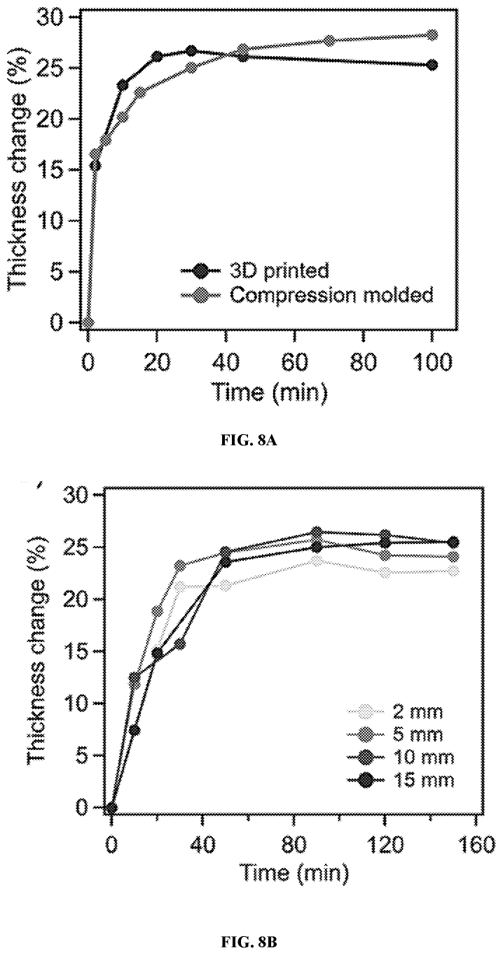

The expansion annealing process was applied to PP samples of varying thicknesses as well as bulk samples at 50° C. to evaluate the influence of the critical sample dimension and structure on the swelling behavior of printed specimens. Geometries examined included step-like printed samples with thicknesses ranging from 2-15 mm, as well as compression molded and 3D-printed rectangular prisms (with average thicknesses of ~0.6 mm) (FIGS. 8A-8B). For the step-like samples, all regions swelled uniformly and reached equilibrium after ~90 min regardless of thickness, with less than 3% variation in thickness change. Similarly, both compression molded and printed prisms reached equilibrium after ~50 min, with a dimensional variation of only ~3%. These results indicate that the swelling behavior of PP is dictated by diffusion of xylene through the amorphous phase of the material and is largely independent of sample thickness or processing method; this characteristic feature of expansion annealing enables the scaling of the annealing process of the present disclosure to samples with large feature sizes.

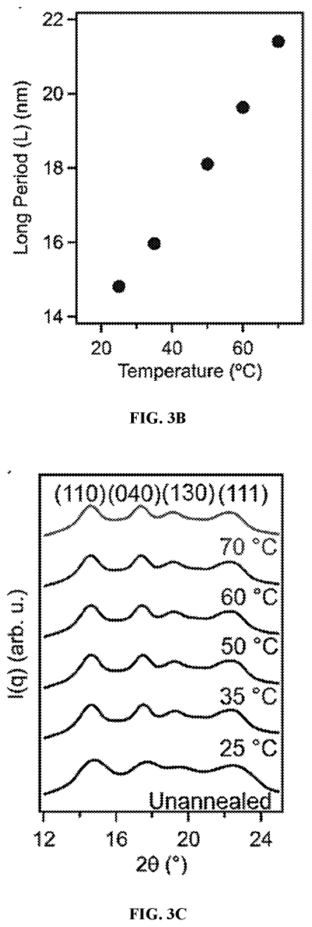

In-situ small-angle X-ray scattering (SAXS) and wide-angle X-ray scattering (WAXS) were performed on model samples immersed in xylene at temperatures ranging from 25° C. to 70° C. to understand the effects of the annealing process on the mesoscale morphology of the samples. For all samples, regardless of annealing temperature, Lorentz-corrected SAXS profiles showed a primary scattering peak, corresponding to the long period (L), indicating that the PP material remained in its semi-crystalline state during the annealing process. The position of the primary scattering peak (q*) shifted as annealing temperatures increased, indicating a significant expansion of the amorphous phase (FIG. 3A). Specifically, the neat sample displayed an L of 11.3 nm in the dry state.

After immersion in xylene at 35° C., 50° C., and 60° C., L increased to 16.0 nm, 18.1 nm, and 19.6 nm, corresponding to 42%, 60%, and 73% increases, respectively, compared to the neat state (FIG. 3B). The increase in L at higher annealing temperatures was attributed to partial melting of crystalline lamellae, which reduced the sample crystallinity, enabling the larger amorphous fraction to permit a greater degree of swelling. WAXS results displayed characteristic diffraction peaks indicating that the PP material existed in its monoclinic form, as shown in FIG. 3C.^{46,47} These peaks persisted across all annealing temperatures examined, confirming that the expansion annealing process did not disrupt the unit-cell structure of PP crystalline domains.

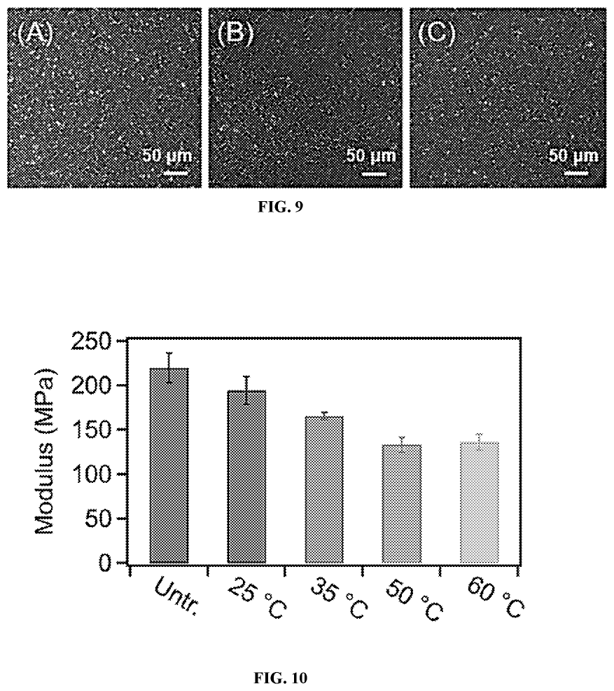

Moreover, polarized optical microscopy (POM) was used to characterize PP crystalline spherulites before, during, and after expansion annealing (FIG. 9). Upon exposure to xylene at 50° C., birefringence intensity decreased, indicating a reduced crystalline fraction consistent with partial lamellar melting (FIG. 9, images A and B). After drying, birefringence recovered as a result of PP chain recrystallization (FIG. 9, image C). These observations align with scattering results showing that the semi-crystalline morphology was preserved during the annealing process and that the expansion of amorphous regions in PP samples was temperature-dependent.

### Example 5

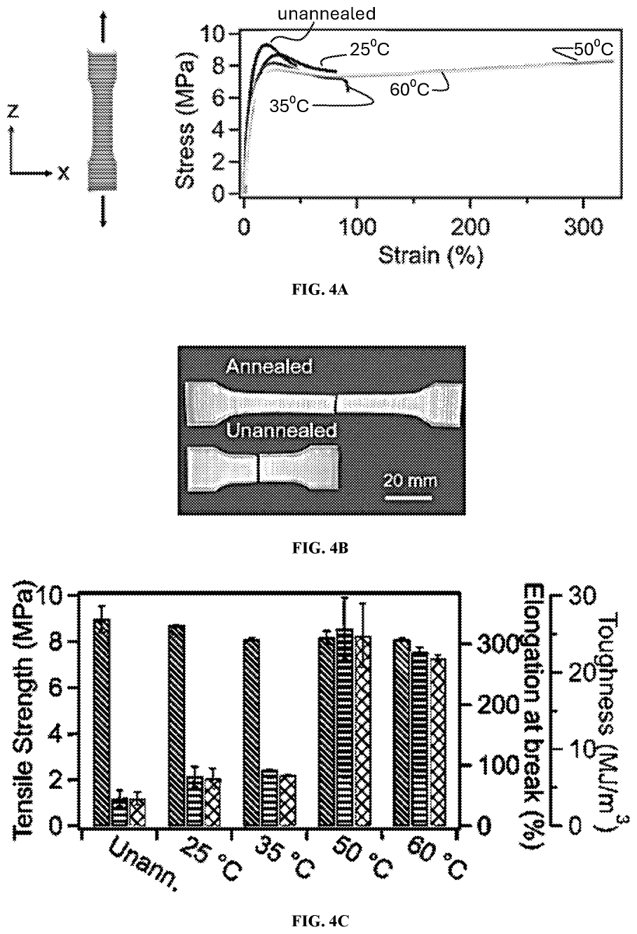

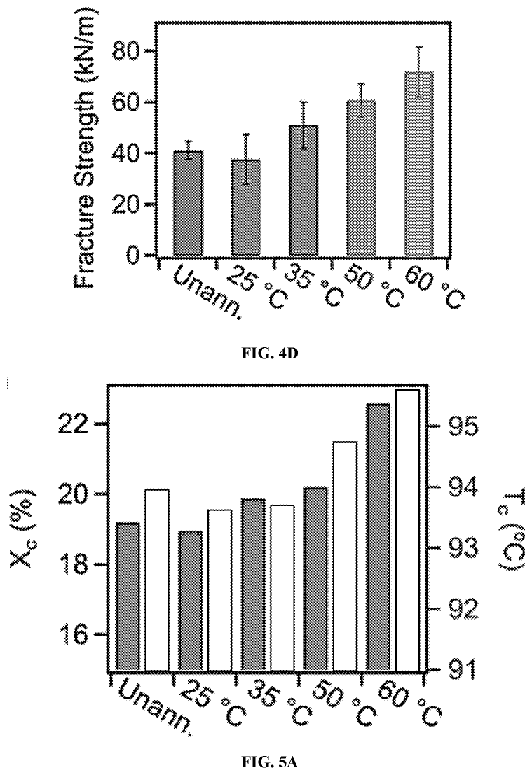

To understand the impact of expansion annealing on sample mechanical properties, in one exemplary embodiment, dog-bone specimens were printed (following a modified ASTM D638 standard) with a build direction along the out-of-plane orientation (z-axis) (FIG. 4A). All samples underwent a standardized annealing process: immersion in xylene for 150 min at 25° C., 35° C., 50° C., or 60° C., followed by cooling to room temperature prior to removal and drying. Tensile tests were then performed along the z-direction, applying a load normal to the layer deposition direction. As shown in FIG. 4B, the unannealed specimen was relatively brittle, exhibited minimal yielding, and failed at <50% elongation. After immersion in xylene at 50° C. and 60° C., the sample mechanical response changed substantially (FIG. 4A). These annealed specimens showed a clear yield point, modest strain hardening behavior, and ductile failure. Expansion annealing at 25° C.-35° C. produced limited improvements, which suggests a minimum swelling condition is required to promote interlayer adhesion in these PP parts.

FIG. 4C quantifies mechanical property improvements as a function of expansion annealing temperature. Annealing at elevated temperatures dramatically enhanced material toughness, increasing from 3.57 MJ/m³ for unannealed specimens to 6.2 MJ/m³, 6.7 MJ/m³, 25 MJ/m³, and 22 MJ/m³ after annealing at 25° C., 35° C., 50° C., and 60° C., respectively. Elongation at break values also greatly improved, rising from 46% to 82%, 93%, 330%, and 290% when immersed at 25° C., 35° C., 50° C. and 60° C., respectively. The considerable improvements observed in sample ductility after annealing at 50° C. and 60° C. were attributed to amorphous phase expansion through partial lamellar melting, which allowed for the formation of interlayer crystallites and an increase in tie chain molecules upon re-crystallization resulting from solvent removal and sample cooling.

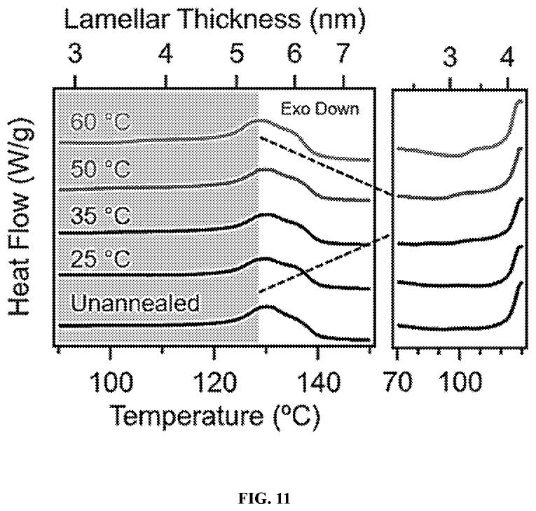

Furthermore, the limited ductility improvements observed after annealing at 25° C. and 35° C. suggest that temperature is a key parameter governing the extent of sample swelling and crystalline domain melting, which in turn dictates the properties of the annealed samples. Reductions in both tensile strength and modulus were observed for annealed specimens when compared to the as-printed state. The tensile strength of samples annealed at 25° C., 35° C., 50° C., and 60° C. decreased from 9.0 MPa to 8.7 MPa, 8.1 MPa, 8.2 MPa, and 8.1 MPa (decreases of 3.3%, 9.7%, 8.8%, and 9.7%, respectively). Modulus values also decreased with increasing annealing temperature, diminishing from 220 MPa to 194 MPa, 166 MPa, 133 MPa, and 136 MPa after annealing at 25° C., 35° C., 50° C., and 60° C., respectively (FIG. 10). The decrement in tensile strength and modulus values resulted from the crystal re-structuring due to the expansion annealing treatment.^{48,49}

Overall, the significant improvement in elongation at break and toughness of printed PP parts confirms the enhanced interlayer adhesion after annealing at elevated temperatures. To corroborate this, trouser-tear tests (ASTM D624) were performed on out-of-plane printed specimens. Average fracture strength values of samples annealed at 25° C. were comparable to the neat sample, but they increased substantially with higher annealing temperatures, showing an improvement of 24% at 35° C., 47% at 50° C., and 75% at 60° C. (FIG. 4D), further demonstrating enhanced interlaminar bonding. These results, together with the tensile tests, confirm that expansion annealing strengthens interlayer adhesion via sample swelling and deswelling. Specifically, the improvement stems from amorphous domain expansion during annealing, which promoted interlayer crystallites. Additionally, it was found that mechanical performance enhancements increased with the degree of sample swelling, and thus a minimum dimensional expansion threshold was required to achieve meaningful improvements.

### Example 6

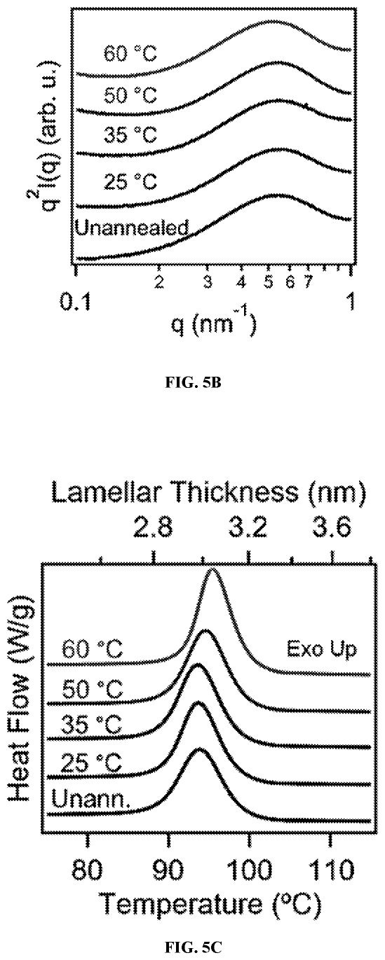

While prior studies have shown that increased chain entanglement can improve the interlayer strength and mechanical response of MEX-printed parts, most focused on glassy, rigid polymers, where chain entanglement dominates the sample mechanical performance.⁵⁰ In the present disclosure, this system uses PP which exhibits low T_{g}, and shows that entanglements alone are insufficient as polymer chains could be pulled and disentangled easily under tensile load. In commodity polyolefins, mechanical response is governed by crystalline morphology and tie-chain formation.^{51,52} Accordingly, the ability of the annealed samples to sustain load transfer across distinct layers is attributed to their semi-crystalline microstructure. To further elucidate the mechanistic origin of the mechanical property improvements from expansion annealing, DSC analysis (FIG. 11) of neat and annealed PP specimens was performed to understand their degree of crystallinity (X_{c}). Neat PP exhibited an X_{c} of approximately 19%, which remained essentially unchanged after annealing at 25° C. Annealing at higher temperatures increased sample crystallinity, reaching 19.9%, 20.2%, and 22.6% after immersion at 35° C., 50° C., and 60° C., respectively (FIG. 5A).

Moreover, the crystallization temperature (T_{c}, FIG. 5A) of these PP specimens also increased with expansion annealing temperature, from 94° C. (neat) to 95° C. and 96° C. after immersion at 50° C. and 60° C., respectively. These trends indicate that, upon xylene removal, polymer chains can recrystallize and enhanced interlayer crystallites/entanglement formation during the solvent-induced swelling state facilitates additional crystal formation across adjacent layers within the printed parts. The higher T_{c} in annealed samples suggests the samples crystallize more readily, likely due to improved chain organization and interlayer entanglement that facilitate nucleation and lamellar growth.

### Example 7

The crystallization behavior of dual- and single-layered specimens was then investigated to distinguish the effect of expansion annealing on 3D printed as well as bulk PP specimens, respectively. As shown in FIG. 5B, SAXS results of dried PP samples annealed between 25° C. and 60° C. show a small variation of L less than 0.6 nm relative to the unannealed neat sample, indicating near complete recovery of the amorphous domain after xylene removal, consistent with the observed macroscopic return to original dimensions. Lamellar thickness distributions of the single-layered specimens, created by utilizing the cooling thermogram, displayed a shift toward larger crystallites with increasing immersion temperature (FIG. 5C). Unannealed samples exhibited a peak position at 2.97 nm. After annealing at 25° C., this peak position shifted slightly to lower thickness values, with a peak position located at 2.96 nm. It was noted that the lamellar thickness distribution of samples annealed at 35° C. possessed a similar peak position to the neat sample at ~2.97 nm. Upon immersion at 50° C. and 60° C., however, the peak positions shift towards slightly larger thicknesses, with values of approximately 3.00 nm and 3.03 nm, respectively.

Lamellar thickness distributions of the dual-layered specimens, based on first-heat melting thermograms, displayed a similar trend with small shoulders appearing after annealing at elevated temperatures (FIG. 11). The appearance of these shoulders indicated a new crystalline melting event which shifted to higher temperatures with increasing annealing temperature. Specifically, the shoulders displayed peak positions of 3.24 nm and 3.36 nm after annealing at 50° C. and 60° C., respectively. This crystallization behavior further suggests that expansion annealing enables the formation and growth of interlayer crystallites across distinct printing layers, which can improve sample mechanical properties along the out-of-plane direction.

### Example 8

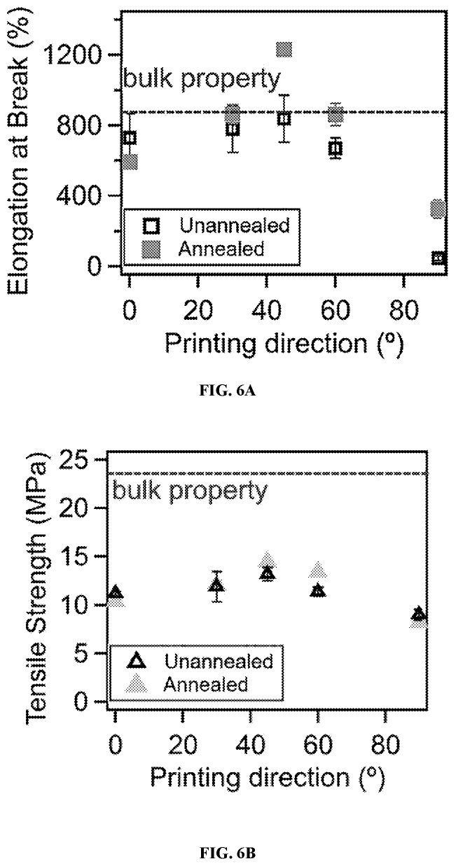

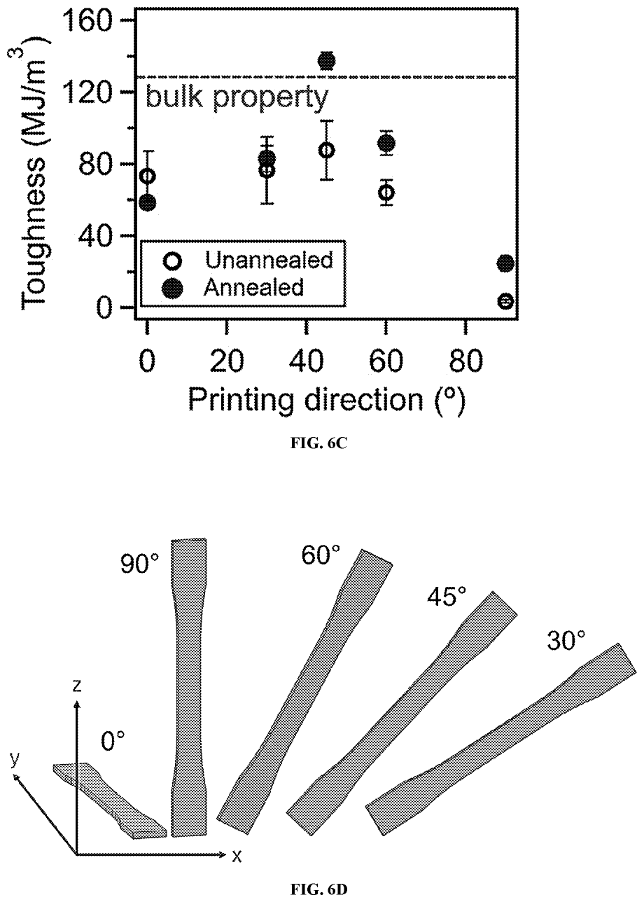

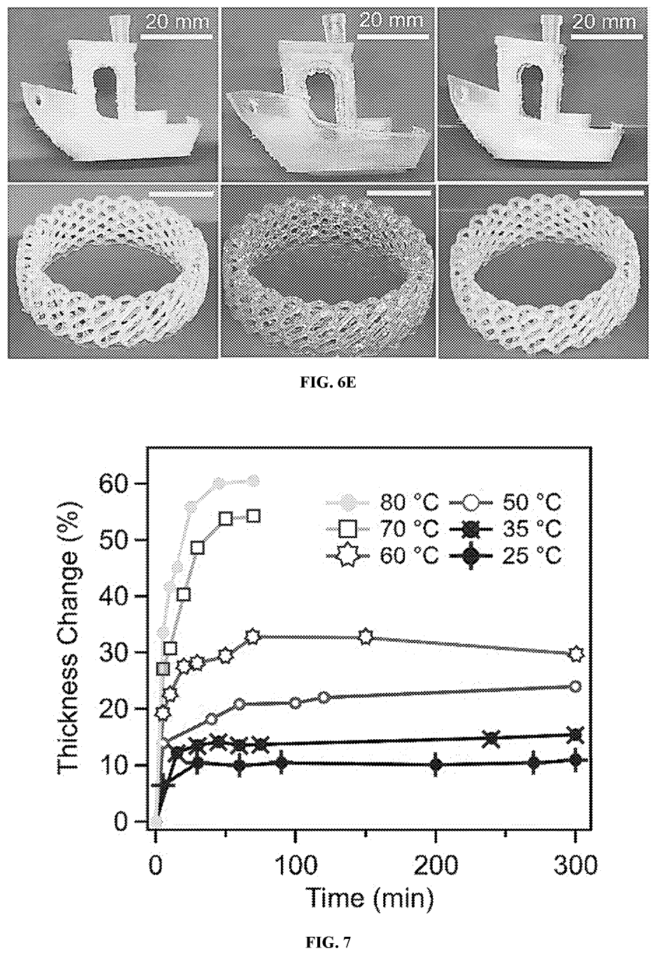

To study how print orientation affects the efficacy of expansion annealing for improving the mechanical properties of PP, tensile specimens were prepared with orientations ranging from in-plane (0°), 30°, 45°, and 60° (with respect to the x-axis) and compared to the results out-of-plane) (90° annealed and unannealed samples (as well as bulk, compression molded PP type IV ATSM D638 tensile bars—with properties indicated by the red dashed line in FIGS. 6A-6C).

In these experiments, all samples were annealed at 50° C. for 150 min and then dried under vacuum to remove residual xylene. An illustration of tensile specimen MEX print orientation is shown in FIG. 6D. For 0° printed specimens, expansion annealing caused slight reductions in tensile strength (−7.2%), toughness (−20%), and elongation at break (−19%), compared to the neat sample (FIGS. 6A-6C). The decrement in properties observed for these specimens arose because they were evaluated with a load parallel to the filament deposition orientation; thus, improved interlayer adhesion had little impact on their tensile response. Instead, another factor likely dominated: disruption of printing-induced chain alignment. Expansion annealing promotes chain expansion, relaxing the amorphous network from a mildly aligned state toward a more isotropic configuration. This can reduce load transfer along the filament axis, even as crystallinity increases.

However, as the tensile orientation shifted towards a 90° orientation (i.e. at 30°, 45°, and 60°), the properties of the annealed specimens gradually improved, eventually approaching bulk properties (FIGS. 6A-6C). Specifically, specimens with a 30° orientation experienced a slight increase in tensile strength, toughness, and elongation at break from 11.9 MPa, 76.6 MJ/m³, and 781% (for unannealed, 3D printed specimens) to 12.1 MPa, 83.1 MJ/m³, and 865% upon annealing (increasing by 0.7%, 7.6%, and 10%), respectively. Samples with 45° and 60° printing orientations exhibited significant improvements, with tensile strength improving from 13.2 MPa and 11.4 MPa—for unannealed, MEX printed samples—to 14.5 MPa and 13.4 MPa, respectively; toughness improving from 87.7 MJ/m³ and 64.2 MJ/m³ to 137 MJ/m³ and 91.7 MJ/m³, respectively; and elongation at break improving from 839% and 671% to 1230% and 864%, respectively.

Moreover, tensile properties of annealed samples printed with a 45° orientation exceeded bulk tensile properties, with toughness increasing from 129 MJ/m³ to 137 MJ/m³ and elongation at break improving from 876% to 1231%. The improvements shown by samples oriented closer to the out-of-plane (z) direction represent the advantages gained by employing expansion annealing, as the improved interlayer adhesion further enhances load transfer across interlaminar interfaces and yields superior tensile properties.

### Example 9

The applicability and versatility of the expansion annealing method was confirmed by demonstrating geometrically complex prints, including a standard Benchy and an open-celled disk. Both parts were subjected to annealing in xylene at 50° C. for 150 min, followed by a complete drying process. FIG. 6E shows images of printed parts pre-immersion, immediately post-immersion, and post-drying using identical camera settings. Upon immersion, the disk and boat structures exhibited swelling of ~20% and ~15% in characteristic lengths, respectively (outer diameter and height for the disk; overall length for Benchy). After solvent removal and drying, each structure returned to its original dimensions within a <1% deviation, with no noticeable warpage or feature collapse. These results indicate that expansion annealing can be implemented on complex, non-prismatic architectures without sacrificing dimensional fidelity, attributed to the retention of the semi-crystalline framework upon swelling.

In conclusion, the present disclosure addresses a central bottleneck in MEX-AM, associated with poor interlayer adhesion within printed parts, by developing expansion annealing as a post-manufacturing annealing method. By immersing printed PP parts in xylene at elevated temperatures, the solvent penetrates and selectively swells the amorphous phase to promote interlaminar chain interaction and entanglement formation, while the retention of crystalline lamellae maintains part geometry. Upon drying, chains recrystallize across interfaces, forming interfacial crystallites (tie chains) that markedly strengthen interlayer adhesion. The present method requires no special equipment or custom filaments, preserves the semi-crystalline microstructure, and can be adapted to complex geometries-offering a simple, scalable, drop-in annealing process that strengthens interlayer adhesion post-AM.

### Example 10: Bio-Based Polyethylene (bPE)

Bio-based polyethylene (bPE) material extrusion (MEX) additive manufactured (AM) samples were immersed in xylene at temperatures ranging from 50° C. to 85° C., with all samples approaching equilibrium after annealing for 50 min of immersion and reaching swelling equilibrium, regardless of solvent temperature, after 100 min of immersion. Additionally, samples experienced a range of equilibrium swelling thicknesses which increased with temperature, namely, samples immersed at 50° C., 65° C., 75° C., and 85° C. experienced an equilibrium swelling thickness of approximately 10%, 15%, 20%, and 27%. After drying, samples exhibited less than a 4% change in dimensions relative to the unannealed sample.

Tensile properties of bPE samples were assessed after annealing samples at the temperatures listed above for 150 min. After annealing, samples were vacuum dried at 40° C. for 48 h to remove residual solvent. The elongation at break and toughness values increased from approximately 75.5% and 10.0 MJ/m³ to 97.3% and 11.3 MJ/m³, respectively, after annealing samples at 80° C. (increases of approximately 30% and 13%, respectively). Additionally, trouser tear specimens were evaluated after annealing to assess the effect of expansion annealing on the fracture strength of MEX-printed bPE samples. After annealing at 80° C., the fracture strength increased from 9.95 kN/m for the unannealed sample to 12.1 kN/m, a 22% increase.

Differential scanning calorimetry (DSC) was utilized to assess the effect of expansion annealing on the microstructure of bPE specimens. The degree of crystallinity (X_{c}) of bPE increased with increasing immersion temperature, increasing from 43.9% for the unannealed sample to 44.6% and 47.4% after annealing at 75° C. and 85° C., respectively.

### Example 11: Polylactic Acid (PLA)

Polylactic acid (PLA) MEX-printed samples were immersed in varying volumetric ratios of acetone, a good solvent for PLA, and isopropyl alcohol (IPA), a poor solvent for PLA, to induce solvent penetration and sample swelling/chain mobility while avoiding material dissolution. The volumetric ratios of the solvents IPA to acetone utilized to create immersion solutions were 95:5, 90:10, 85:15, and 80:20.

Swelling kinetics studies were performed utilizing the solutions of IPA and acetone discussed above. Immersion was conducted under ambient conditions (approximately 20° C.), and swelling equilibrium was achieved after approximately 24 h for all solution compositions. The equilibrium thickness changes for the solvent compositions were 1.3%, 1.9%, 5.8%, and 9.6%, for solvent compositions of 95:5, 90:10, 85:15, and 80:20 IPA:acetone, respectively. Compression specimens were printed in accordance with ASTM D695 and immersed for 24 h under ambient conditions prior to being removed and vacuum dried for 48 h at 40° C. to remove residual solvent. After annealing, samples possessed enhanced compressive properties, with the compressive yield strength and modulus increasing from 4.2 MPa and 130 MPa for the unannealed specimens, respectively, to 9.3 MPa and 204 MPa, 9.0 MPa and 206 MPa, and 5.6 MPa and 147 MPa for the 95:5, 90:10, and 85:15 solvent compositions, respectively. Additionally, trouser tear experiments were utilized to understand how expansion annealing affected the tear strength of 3D printed PLA specimens. After annealing and vacuum drying samples immersed in solvent compositions having ratios of IPA to acetone of 95:5 and 80:20, the tear strength improved from 3.4 kN/m to 4.1 kN/m and 6.7 kN/m, respectively (19% and 96% increases, respectively).

DSC was utilized to understand how the expansion annealing process affected the morphology of the MEX-printed PLA specimens. After annealing and drying, PLA specimens exhibited an increase in both X_{c} and T_{g}, from 0.7% and 57° C. to 8.5% and 57° C., 28% and 60° C., 29% and 60° C., and 32% and 59° C. for the solvent compositions having ratios of IPA:acetone of 95:5, 90:10, 85:15, and 80:20, respectively.

### Example 12: Acrylonitrile Butadiene Styrene (ABS) Amorphous Polymer

Amorphous acrylonitrile butadiene styrene (ABS) 3D printed samples were immersed in varying volumetric ratios of IPA (a poor solvent for ABS) and chloroform (a good solvent for ABS) to induce sample swelling while avoiding material dissolution. The volumetric ratios utilized for the solvents were 95:5, 90:10, 85:15, and 80:20 IPA:chloroform.

Swelling kinetics experiments were conducted using the solvent compositions listed above and the samples were immersed at ambient conditions (20° C.). All samples, regardless of fraction of good solvent employed, obtained swelling equilibrium after 24 h. Furthermore, equilibrium thickness changes of 6.3%, 9.5%, 12%, and 18% were achieved for solvent ratios of 95:5, 90:10, 85:15, and 80:20 IPA:chloroform, respectively.

ABS compression samples were printed in accordance with ASTM D695 and immersed for 24 h in the solvent compositions discussed above before being removed and vacuum dried at 40° C. for 48 h. The compressive yield strength and moduli of the samples improved from 21 MPa and 282 MPa for unannealed samples to 22 MPa and 293 MPa for samples immersed in a 95:5 IPA:chloroform solution (4.1% and 4.0% increases), respectively.

This example demonstrates that the expansion annealing process of the invention can be applied to amorphous polymers as well as semi-crystalline polymers and that significant benefits can also be realized for these amorphous polymers.

### Example 13: Polypropylene (PP) Experiments

### Materials Preparation

UltiMaker S series, natural polypropylene (PP) filament with a diameter of 2.85 mm was purchased from UltiMaker and used for material extrusion additive manufacturing and compression molding of specimens employed during this experiment. 3D printed specimens were created using an UltiMaker S3 printer with an UltiMaker AA 0.4 mm print core. For 3D printing of the PP filament, a nozzle temperature of 215° C., a bed temperature of 80° C., and a fan speed of 20% were used. Generally, mechanical specimens were printed with either a 90° or 0° raster angle (relative to the x-axis of the printing bed), a line infill geometry, and an infill density of 100% to ensure specimen uniformity and consistency. Additionally, Magigoo adhesive was applied to the bed prior to each printing run and a brim was added to each specimen model in the Cura slicing software before printing to allow for sufficient bed adhesion and avoid sample warpage. Generally, a printing speed of 30 mm/s was used for printed specimens, however, printing speeds were modified and supporting material was utilized for specimens depending on their geometry and print orientation to avoid print failures. All 3D models used for printing throughout this experiment were either fabricated using Autodesk Fusion or were downloaded directly from Thigiverse.com. Furthermore, bulk samples of PP were generated via compression molding using a Carver 4386 manual press at a temperature of 215° C.

### Sample Annealing

Expansion annealing of PP specimens was achieved by submerging specimens in a crystallization dish containing xylene (Fisher Scientific, Certified ACS) at varying temperatures (from 25° C. to 80° C.) with constant stirring and the addition of an external thermocouple to ensure consistent solvent temperature throughout the immersion vessel. Annealing conditions were maintained for all samples, with specimens being immersed for 150 min (well past the point of swelling equilibrium) before being allowed to return to room temperature and being removed from the solvent. The samples were then either allowed to dry under ambient conditions for at least 72 h or dried under vacuum for 48 h at 40° C. before final measurements were recorded and subsequent characterization was performed.

### General Characterization

To understand the behavior of PP parts upon immersion in xylene at different temperatures, swelling kinetic experiments were performed on printed disk specimens with a thickness of 2 mm and a diameter of 24 mm. For these experiments, the change in sample thickness was monitored over time (5-300 min) to establish the point of swelling equilibrium. Dimensional measurements were taken immediately after sample removal from the annealing bath to avoid solvent evaporation. In addition, the mass and dimensions of all PP samples utilized in this experiment were monitored before immersion, immediately after removal from solvent, and after drying to ensure solvent removal and evaluate structural changes and recovery.

Differential scanning calorimetry (DSC) experiments were performed utilizing a TA Instruments Discovery DSC 250 with aluminum pans. Experiments were conducted under nitrogen using a heat-cool-heat cycle with a ramp rate of 5° C./min from 40° C. to 160° C., a cooling rate of 10° C./min from 160° C. to −60° C., and a final heating ramp of 5° C./min from −60° C. to 160° C. For annealed samples, the first heat thermogram was analyzed to determine the sample melting temperature (Tₘ) and degree of crystallinity (X_{c}). The first heat and cooling thermograms were then employed to calculate the lamellar thickness distribution of samples after immersion using the equation below, where

$$\frac{1}{M} \frac{dM}{d l}$$

represents the population of lamellae within a range of lamellar thicknesses that melt in a given temperature range, dE/dT represents the energy required to melt the lamellae, ρ_{c} is the density of the crystalline phase, and σₑ is the surface energy of the basal surface of a crystal.¹

$$\frac{1}{M} \frac{dM}{d l} = \frac{d E}{dT} \frac{{( {T}_{m}^{0} - {T}_{m} )}^{2} {ρ}_{c}}{2 {σ}_{e} {T}_{m}^{0} M} \qquad ( 1 )$$

The cooling thermogram was also used to determine the crystallization temperature (T_{c}). All data was analyzed using Trios software.

Polarized optical microscopy (POM) images were collected with an Olympus BX53M Upright LED Polarized Brightfield Darkfield microscope fitted with an Instec mK100, HCS302 temperature controller. Thin cross sections of unannealed and annealed tensile specimens were taken using a razor blade, placed on a microscope slide, and enveloped by circular cover glass before being heated from ambient to 160° C. (above Tₘ) at 10° C./min. After holding samples at 160° C. for 10 min to ensure complete melting, pressure was applied to the cover glass until a thin film was formed to ensure image clarity. Samples were then cooled to 90° C. at 10° C./min and allowed to recrystallize under isothermal crystallization conditions for 5 min before being imaged. In situ sample imaging was performed by cooling the unannealed sample further to 50° C. at 10° C./min before administering xylenes. The sample was permitted to equilibrate for 5 min before micrographs were recorded. All micrographs were recorded using a Q-Imaging RoHS camera (2048 pixel×1536 pixel) in transmission mode at an angle configuration of 90° between the linear polarizer and the linear analyzer.

Tensile properties of 3D printed PP were determined following a modified ASTM D638 standard with a modified type I tensile bar.² Generally, samples were printed with a nominal gauge length of 25 mm, a thickness of 4 mm, and a width of 12.5 mm and were examined using an MTS Insight mechanical testing frame equipped with a 2.5 kN load cell at a strain rate of 5 mm/min. Similarly, bulk PP type IV tensile bars were compression molded at 215° C., with a nominal thickness of 4 mm and a width of 6 mm, and evaluated following ASTM D882 standards, with a strain rate of approximately 40 mm/min, employing the same mechanical testing frame equipped with a 500 N load cell.³ Trouser tear specimens were printed in accordance with ASTM D624 standards to determine the fracture strength of specimens before and after expansion annealing.⁴ Samples were printed out-of-plane, with the initial tear being introduced by pausing mid-print and taping a piece of paper—cut to the length dictated by the ASTM (40 mm)—across the samples before resuming the print. An MTS Insight mechanical testing frame equipped with a 2.5 kN load cell and a strain rate of 50 mm/min were used for the tear test experiments. The fracture strength was calculated based on the load vs extension curves using the equation below:

$$T = \frac{2 F}{t} \qquad ( 2 )$$

where T represents the fracture strength, F represents normal force, and t represents the sample thickness. Data collection and analysis were performed using TestWorks and Igor Pro 9 software, respectively.

In situ Small-angle X-ray scattering (SAXS) and wide-angle X-ray scattering (WAXS) measurements were performed using a Xeuss 3.0 system (Xenocs, Grenoble, France) equipped with a GeniX 3D beam delivery system, which provided monochromatic Cu Kα radiation. Scattering patterns were collected using a Dectris Eiger 2R 1M-pixel 2D detector and reduced into an integrated 1D profile. The sample-to-detector distance was set to 0.045 m for WAXS and 0.9 m for SAXS measurements. For annealing experiments, small sections of unannealed tensile bar samples were soaked in p-xylene, sealed in 1.5 mm diameter capillaries, and loaded into a Linkam stage. The temperature was increased at a rate of 20° C./min and held for 30 min or 1 h prior to recording measurements. The samples were exposed to the X-ray beam for 300 seconds and 900 seconds for WAXS and SAXS measurements, respectively. Static SAXS measurements were recorded at the 5-ID-D (DND-CAT) beamline of the Advanced Photon Source at Argonne National Laboratory. A sample-to-detector distance of 8.5 m and an exposure time of 0.5 seconds were used for all measurements. Two-dimensional scattering patterns were collected with a MarMosaic 225 detector, azimuthally averaged, and reduced to one-dimensional data using software developed by beamline scientists at 5-ID-D.

What is claimed is:

1. An additive manufactured product comprising a plurality of printed layers of a partially or completely amorphous thermoplastic composition wherein adjacent layers of the plurality of layers are bonded by interfacial crystallites extending between the adjacent layers.

2. The additive manufactured product of claim 1, wherein the thermoplastic composition comprises one or more polymers selected from the group consisting of polyolefins, polylactic acid, acrylonitrile butadiene styrene, polyethylene terephthalate glycol, polycarbonate, thermoplastic polyurethane and polyamide.

3. The additive manufactured product of claim 2, wherein the polymer is a polyolefin selected from the group consisting of polyethylene and polypropylene.

4. The additive manufactured product of claim 1, wherein the thermoplastic composition is semi-crystalline.

5. The additive manufactured product of claim 1, wherein the thermoplastic composition is amorphous.

6. The additive manufactured product of claim 1, wherein the interfacial crystallites have an average lamellar thickness greater than an average lamellar thickness of the crystalline domains within the layers.

7. A method of making an additive manufactured product, comprising steps of:
additive manufacturing a composition comprising a partially or completely amorphous thermoplastic composition to form an additive manufactured article;
immersing the additive manufactured article in one or more solvents in which the additive manufactured article is essentially insoluble at a temperature of at least 20° C. and below a boiling temperature of the one or more solvents to swell the additive manufactured article; and
drying the additive manufactured article after the immersing step to form the additive manufactured product.

8. The method of claim 7, wherein the thermoplastic composition comprises one or more polymers selected from the group consisting of polyolefins, polylactic acid, acrylonitrile butadiene styrene, polyethylene terephthalate glycol, polycarbonate, thermoplastic polyurethane, and polyamide.

9. The method of claim 7, wherein the thermoplastic composition is amorphous.

10. The method of claim 7, wherein the thermoplastic composition is semi-crystalline.

11. The method of claim 7, wherein the temperature is from about 20° C. to about 85° C.

12. The method of claim 7, wherein the step of immersing the additive manufactured article in the solvent isotropically swells the additive manufactured article by 1% to 61%, based on a volume of the additive manufactured article prior to immersion.

13. The method of claim 7, wherein the step of immersing the additive manufactured article is carried out for a duration of from about 50 minutes to about 24 hours.

14. The method of claim 7, wherein the one or more solvents is selected from the group consisting of xylenes, aromatic hydrocarbons, ketones, esters, aliphatic alcohols, aliphatic hydrocarbons, aliphatic diols, halogenated solvents, aprotic polar solvents, and combinations thereof.

15. The method of claim 7, wherein the step of drying is carried out for a duration of 24 hours to 168 hours under ambient drying conditions or by at a temperature higher than room temperature under vacuum.

16. An additive manufactured product formed by the method claim 7.

17. The additive manufactured product of claim 16, having an improvement in toughness of at least 73% and up to 596%, relative to the additive manufactured product prior to the immersing step.

18. The additive manufactured product of claim 16, having an improvement in tear strength of at least 24% and up to 75%, relative to the additive manufactured product prior to the immersing step.

19. The additive manufactured product of claim 16, having an improvement in an elongation index of at least 77% and up to 605%, relative to the additive manufactured product prior to the immersing step.

20. A method of improving isotropy of an additive manufactured product comprising steps of:
immersing the additive manufactured product comprising a partially or completely amorphous thermoplastic composition in a solvent in which the thermoplastic composition is essentially insoluble at a temperature of at least 20° C. and below a boiling temperature of the solvent to swell the additive manufactured product; and
drying the additive manufactured article after the immersing step to form the additive manufactured product.

21. A method of improving interlaminar crystallization and interlayer adhesion of an additive manufactured product comprising a partially or completely amorphous thermoplastic composition comprising steps of:
immersing the additive manufactured product in a solvent in which the s thermoplastic composition is essentially insoluble at a temperature of at least 20° C. and below a boiling temperature of the solvent; and
drying the additive manufactured product after the immersing step.
